(19) United States
(12) Patent Application Publication
(10) Pub. No.: US 2013/0061994 A1
(43) Pub. Date: Mar. 14, 2013

(54) Tire bead assist device wheel

(71) Applicant: Kevin Kaylin, Gaffney, SC (US)

(72) Inventor: Kevin Kaylin, Gaffney, SC (US)

(21) Appl. No.: 13/573,277

(22) Filed: Sep. 6, 2012

Related U.S. Application Data
(60) Provisional application No. 61/573,562, filed on Sep. 8, 2011.

(51) Int. Cl. B60C 25/00

(52) U.S. Cl. 152/375

(57) ABSTRACT

A vehicle wheel designed to prevent the tire bead of oversized tires from separating from the outer lip of wheel during adverse conditions or when vehicle tires are under inflated, wherein the wheel has spokes, bossed areas or anchor points evenly positioned along the wheel for the purpose of mounting studs, bolts or like fasteners for engaging a set of inner locking rings secured by means of hex nuts, bolts or like fasteners to ensure inner locking rings maintain a direct and constant contact with the inner side of tire bead thus preventing the tire bead from separating from the wheel.

This application claims benefit of provisional application No. 61/573,562 filed on Sep. 8, 2011 entitled “Tire Bead Assist Device Wheel”

### FIELD OF THE INVENTION

This invention relates to wheels used with tubeless tires as a bead assist device on vehicles for on and off-road use.

### BACKGROUND OF THE INVENTION

The following description of the prior art is not intended to be, nor should it be interpreted as, an indication of the common general knowledge pertaining to the invention.

A common problem is that when vehicles use oversized tires, the tire bead can become separated from the wheel when operated at low air pressures as required during off-road use.

On a normal wheel, air pressure pushes against the beads of the tire, firmly pressing them against the outer lip of the wheel. Under normal driving conditions with the tires properly inflated the tire bead seal is adequate to keep the tire firmly attached to the wheel. However, if a vehicle being operated upon the highway loses control and begins to slide sideways or yaw the tire tread can heat up and become sticky from friction as it slides across the road surface which can cause the tire bead to separate from the wheel, instantly deflating the tire, allowing the outer edge/lip of wheel to come in contact with the road surface causing vehicle to overturn.

The off-road vehicle's tires are commonly aired down to very low pressure and are additionally subjected to adverse conditions. Without proper reinforcement the tire bead becomes disassociated from the wheel. This is particularly so in off-road racing, extreme off-road competitions or anywhere where very low tire pressures are involved.

If you decrease air pressure too much, the tire can spin on the wheel. As an example, an off-road vehicle driving in sand may have only 12 psi to improve traction. This decreases the amount of pressure holding the beads onto the wheel, which in turn can cause the tire to spin on the rim.

As a vehicle powers through a turn in deep sand, the outer bead of the front tire can break loose from the wheel and cause an accident. This scenario can also apply to off-road vehicles while rock crawling, mud bogging, or battling snow at low tire pressures.

Standard light truck wheels used with oversized tubeless tires can have problems with the tires rolling off the rim of the wheel. The tire under stress of rock or hill climbing can break the seal where the tire bead seats against the outer lip of the wheel.

Another problem with standard wheels is that when a vehicle is turning or cornering sharply, the centrifugal load on the tire can also cause a separation of the tire bead from the rim, resulting in loss of air and loss of control that can cause damage to the vehicle and a potential rollover situation.

When a tubeless tire is used on off-road vehicles and the off-road vehicle encounters large rocks, the action can cause the tire bead to separate from the rim, which can cause the tire to completely separate from the wheel.

Many off-road competitions push vehicles to extreme limits in order to win at events. In order to win, the driver must be able to operate the vehicle at maximum performance limited only by engine, suspension and driving skills.

There are existing/typical bead lock wheels on the market today that use a tire bead clamping means. Some of these wheels, however, typically provide a flange on the hub that works with a flange on a ring to apply axial forces on either side of the tire bead as a pinch design with pressure being applied from the tightening of various bolts. Inspection and frequent torquing of the bolts is required to these type of designed bead locks to ensure proper pressure is applied to the tire bead to prevent tire from separating from wheel, this applies both when the vehicle is being operated during normal street use or at low air pressure in off-road situations since this type of design relies solely on a clamping/pinching means to keep the tire safely in contact with the wheel.

The present invention provides an improved wheel with an improved tire bead sealing reinforcement means in which the wheel and tubeless tire sealing action work in a novel, safe and unique way that has not yet been used on tubeless tires.

Still another object of the present invention is to provide a safer and easier way to install oversized tires onto wheels while also offering an improved level of safety while driving both on the highway or in off-road situation.

### BRIEF DESCRIPTION OF THE INVENTION

The purpose of the present invention is to provide a specialized wheel for the off-road enthusiast for mounting a tubeless tire, said wheel having a deep drop center allows for easy installation of internal locking rings for means to prevent separation of the tire bead from the wheel, preventing loss of air.

The wheel is provided with a central axis hub and tire bead locking rings within the air chamber of the tire adapted to mount on the hub to secure and lock the bead of a tire between the rings and the outer lip of the wheel.

The improved off-road wheel has a plurality of radically outwardly extended circumferentially spaced mounting or anchor supports that have axially mounted rings wherein the rings comprise a cincture or encircling band about the hub of the wheel.

In other embodiments, the rings shall be adjusted to the needed requirements and may be three, four, or more mounting supports circumferentially spaced within the wheel.

Said axially mounted ring surface mating to the interior or inside surface in a close tolerance fit with the tires inside bead surface. The ring being adjustable to press in and reinforce the tire bead against the outer lip of the wheel.

Wherein the outer lip of the wheel and the circumferentially mounted rings each reinforce the bead surface area of the tire for improved sealing to the degree that a tire with little or no air pressure cannot separate from the wheel.

This sealing means providing a maximized clamping force and in-plane means to strengthen the seal and to prevent bending, warping, twisting, or distortion of the tire bead thus providing a safe and effective sealing means.

A plurality of mounting supports or anchor points are provided with threaded holes in complementary alignment with equally spaced slots or holes on the locking rings for the purpose of secure attachment by means of custom fabricated studs, bolts, set screws, pivotal studs or like fastening means.

Assembly is accomplished by mounting tire onto wheel with outer bead of tire seated on rim. Locking rings are then inserted between the inner non-beaded side of tire and edge of rim. The rings are fitted onto studs or like fasteners and tightened to apply pressure against inner side of tire bead.

Depending upon the application of steel or aluminum, the mounting locations for fasteners may be welded or formed as boss supports, then drilled and/or tapped to accept appropriate threaded or non-threaded fasteners such as custom fabricated studs, bolts, set screws, pivotal studs or other means to secure the locking rings within the wheel.

In one embodiment the fasteners are passed thru the holes within the locking rings and tightened securely to form a complete 360* circle about the wheel. These fasteners may be vertical or horizontal depending upon the desired embodiment chosen.

In still other embodiments there may be formed, welded, or otherwise fastened stud like connectors within the wheel as a securing means to the locking rings which may be fastened or clamped.

A tire is easy to mount with the wheel described because the locking rings slip into and pass beyond the non-beaded opening on the opposite/rear side of the wheel. The rings can then be attached by threading the bolts or set screws into the threaded holes or by positioning the holes of the locking rings so that the studs or like fasteners pass through them and are secure with hex nuts.

The hex nuts are then secured by means of locking type safety pins that are inserted through the pre-drilled holes in the studs or like fasteners. No special tools are required to expand the tire during installation of the locking rings due to the unique deep drop center design of the wheel.

The bead assist device locking means is not only an improvement over prior art, but also an aesthetic and durability improvement to the wheel as well. The mounting system is protected within the air chamber of the tire and is not exposed to the elements on the outer side of the wheel, which in turn also protects the system from collateral damage such as rock strikes caused during extreme off-road situations which is one of the most common causes of failures on other bead lock wheels available on the market today.

The above and other features of the invention will be fully understood from the following detailed description and the accompanying drawings.

### BRIEF DESCRIPTION OF THE DRAWINGS

FIG. 1 is a front plan view of the invention;

FIG. 2 is a cross sectional view of the invention taken from FIG. 1;

FIG. 3 is a rear plan view of the invention;

FIG. 4 is a cross sectional view of the locking ring set;

FIG. 5 is a front plan view of the locking ring set;

FIG. 6 is a perspective view;

FIG. 7 is a cross sectional view showing locking ring set attachment;

FIG. 8 is an elevational view of a fastening stud.

### DETAILED DESCRIPTION OF THE PREFERRED EMBODIMENTS

FIG. 1 shows a plan view of a wheel 20 typical to a standard vehicle wheel that may be utilized on any number of vehicles including trucks, automobiles, SUV, or jeeps. A typical wheel 20 for such vehicles may range from fourteen inches to twenty four inches in diameter and may be larger for some industrial vehicles.

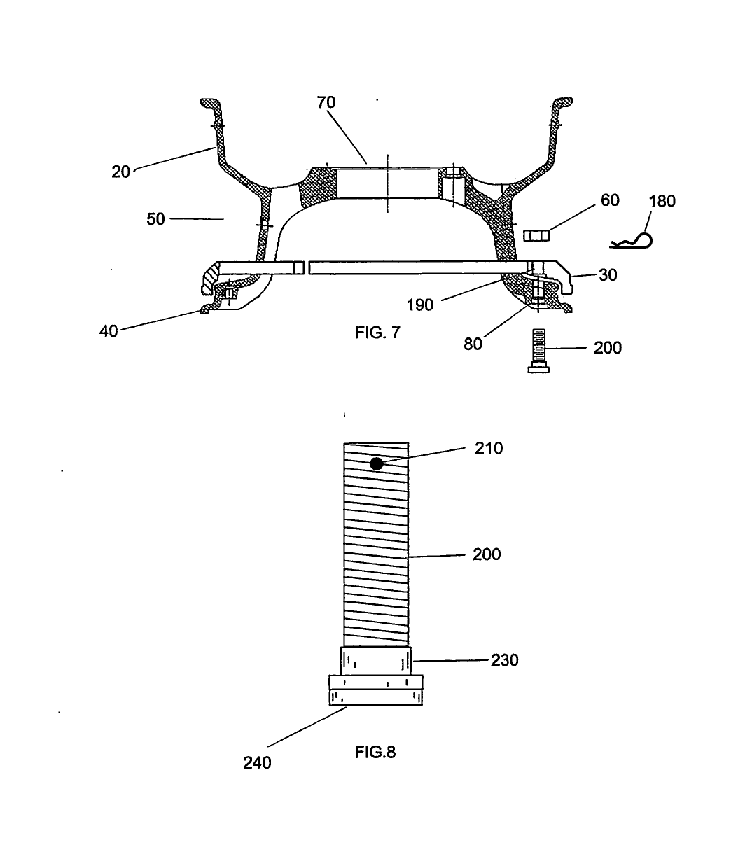

The invention 10 includes three components for securing a tire to the wheel wherein the tire (Not shown of clarity) even with air pressure at zero psi will not slip, slide or separate from the wheel. The first component is the wheel 20 shown in FIGS. 1, 2, 3, 6, and 7.

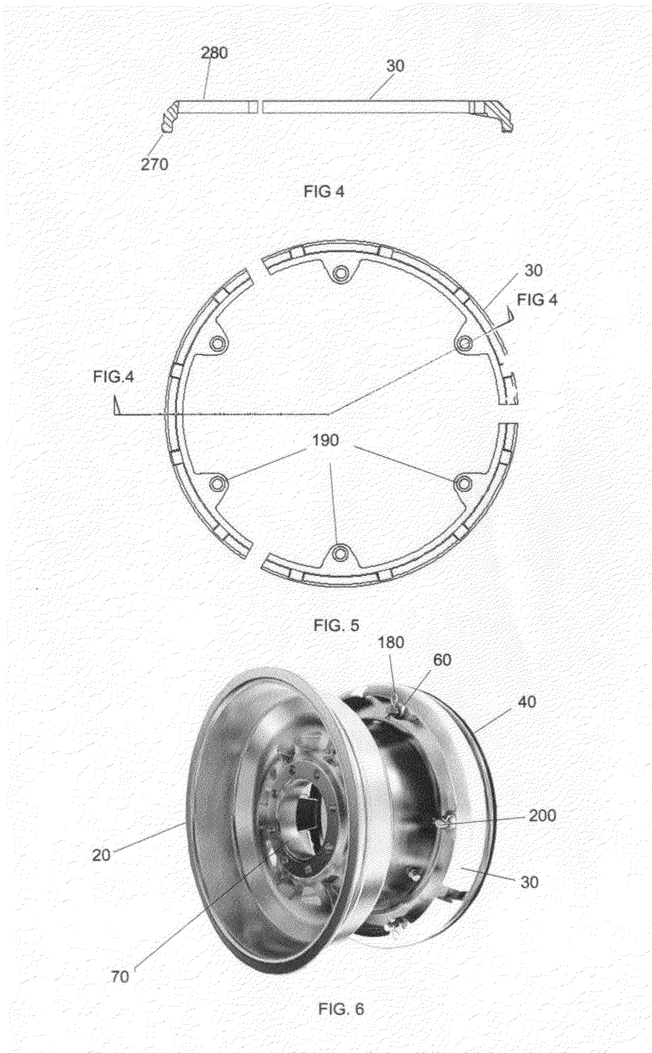

The second component is the inner locking ring set 30 shown in FIGS. 4, 5, 6 and 7. The inner locking ring set 30 is attached to the interior front side of wheel component 20 tightly securing a tire to the wheel.

The inner locking ring set 30 is secured to the wheel by the third component, a plurality of studs 200 shown in FIGS. 1, 6, 7, and 8. These studs pass thru the stud openings 80 on the front of wheel component 20 then thru the inner lock ring set 30 and secured by hex nuts 60 hereinafter described in detail.

A typical wheel 20 as described within this specification may have a multiplicity of openings, slots and or vent holes 90 to reduce weight of the wheel, cooling of vehicle brakes or for aesthetic value and many different visual styles may be utilized without departing from the scope of the invention.

FIG. 1 shows one preferred style and includes six spokes 100 extending outwardly from the central wheel support 110. Central support 110 having centrally located a central circular opening 70 for the purpose of fitting the wheel 20 to a vehicle.

Wheel 20 front, FIG. 1, shall have a plurality of button head hex screws 120 attached in a circular fashion about the outer edge of the wheel 130 for aesthetic value. Said button head hex screws adding to the appearance of a more rugged looking wheel, but serving only as aesthetic value.

Button head hex nut 120 may include any style of screws, bolts or plugs and may be functional or decorative with threaded or pressed in style fastening means.

The rear of the wheel 20 shown in FIG. 3 shall have a functional style and design complementary to the front of the wheel shown in FIG. 1. The Rear of the wheel 20 shown in FIG. 3 may have specifications and or instructions printed or embossed on the wheel 20 as required.

The wheel 20 may also have a removable exterior protective plate or rock ring (Not Shown) for protecting the outer side of wheel from rock strikes and may additionally be secured with a plurality of any suitable fastening means.

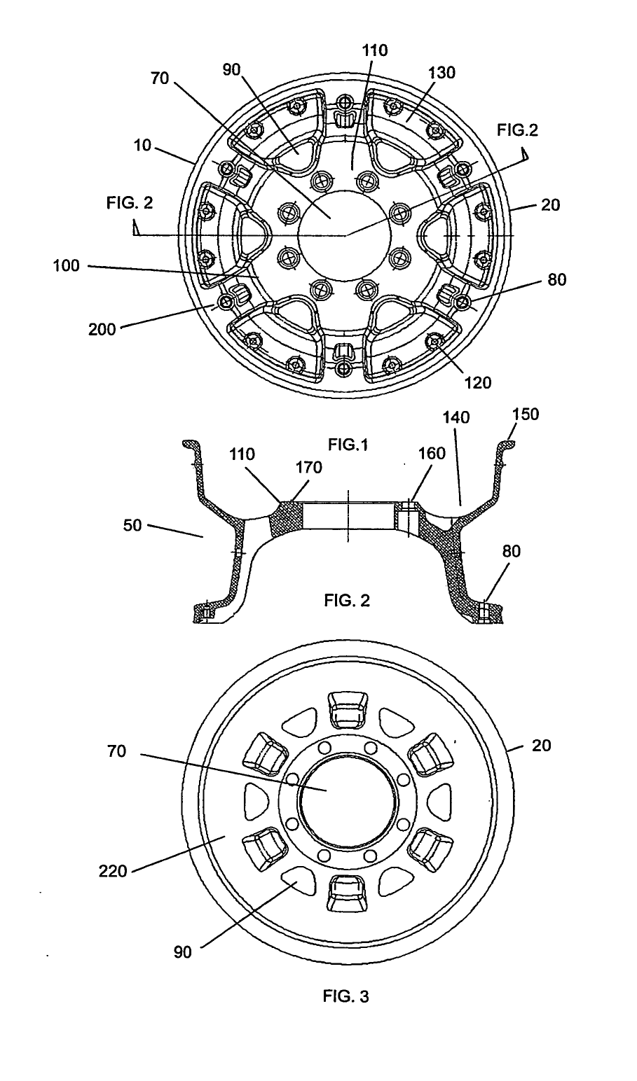

FIG. 2 shows the hub width plane 140 as a swale or recessed form with a diameter less than the outer rim 150 and the inner rim 160. FIG. 2 additionally shows a cross section view of the invention 10 wherein the central wheel support 110 is shown with a central support surface 170 that is flat and complementary to a vehicle hub and mounting studs.

Other embodiments of the invention may include stylized features to incorporate other wheel hub designs and to create improved mounting to the vehicle and to also better secure the inner lock ring set 30 and may include various evenly positioned spokes or boss areas either formed in the manufacturing process of the wheel itself or added later by means of welding.

The wheel may be formed in many different configurations and manufactured with different materials and processes including cast aluminum, billet aluminum, forged aluminum or raw steel and may include a deep drop center and smaller central wheel hub.

Additionally, the wheel may be formed of any rigid metal or alloy products typically used for wheel manufacturing and may consist of any number of shapes and widths and combinations thereof.

The wheel 20 shall have a deep drop center 50 for easy access and ease of placing inner locking rings 30 from the rear of the wheel 220 and allow easier access to within the tire air cavity for attachment of hex nuts 60 to stud 200

Studs 200 shall pass thru the wheel 20 and affix to the inner locking ring set 30 using hex nuts to ensure that the tire bead maintains direct and constant contact with the outer lip 40 of the wheel 20. The studs 200 will typically be custom fabricated ⅝″ diameter×3½″ long and made of a hardened steel material, but other sizes, configurations and materials may be used.

Studs 200 are milled or otherwise drilled to have an opening 210 at the end of the stud as shown in FIG. 8 to accept a locking type pin 180 to prevent a hex nut 60 from backing off the stud 200. Stud 200 furthermore having a rubber grommet 230 near the head 240 of the stud 200 to prevent air from escaping the tire and wheel 20.

Stud 200 may be countersunk or flush to the wheel 20 per manufacturing requirements. Stud 200 may also be milled along the threaded portion to accept roll pins (Not Shown) or similar fasteners designed to prevent studs from backing out of the wheel.

Stud 200 shall pass thru the outer side of wheel 20 into opening 80 and thru the inner locking ring set 30 by hole opening 190 and shall be secured with a hex nut 60 and locking pin 180. A complete automated installation and demonstration video can be seen at:

http://www.youtube.com/watch?v=fCzzy4 mguCs

The inner locking ring set 30 shall be configured to be a strong, non-flexible and substantially rigid circular band adapted to limit the radial expansion of the tire bead adjoining the outer lip of the wheel. The inner locking ring set 30 may be made in two, three, four, or five parts per manufacturers requirements.

However, with this particular diameter of wheel 20, the ideal configuration of inner locking rings 30 is a set of three as seen in FIG. 5 creating a cincture or encircling band with a matching and complementary size to the lip of the wheel and bead of the tire.

The inner locking ring set 30 shall thereby be easy to install, accessing the tire and wheel cavity from the rear of wheel 220 between the tire bead and rear edge of wheel 150. Fastening the rings onto the studs 200 using hex nuts 60 and locking pins 180 provide an improved tire bead sealing means under adverse conditions or when tire air pressure is intentionally operated at very low psi during off-road situations.

The inner locking ring set 30 has a surface substantially parallel to the axis of hub terminating in a radial annulus to the wheel. The inner locking ring set 30 additionally has a similar surface of revolution and annulus to the inner diameter of the surface of the hub.

The inner locking rings 30 on the inner side 270 may have a knurled surface, similar to a saw toothed finish for maximized gripping and bite to the inner surface of the tire bead.

The rear side 280 of inner locking rings 30 shall have a swaged or otherwise flattened surface other than the openings 190 for the studs 200 and shall be designed for easy alignment and construction.

The inner locking rings 30 are installed and positioned with the knurled face 270 of rings 30 in contact with the inner surface of the tire bead. The hex nuts 60 are threaded onto studs 200 then tightened with the appropriate tool to secure the inner locking rings in place.

The hex nuts 60 thus securing the inner locking rings completely. Upon the attachment of the hex nut 60 a locking pin 180 will be inserted in the opening 210 at the outer end of the stud 200 so that the hex nut 60 cannot back off the stud 200.

The inner locking ring 30 thus providing a stiff and rigid structure for locking the tire in place and providing an improvement heretofore unknown means in tire bead locking. Furthermore, no special tools, devices or tires are required.

As required any number of nuts and fasteners may include any number of washers, locking pins or accessories designed to keep bolts tight and secure and may be of a hex, socket or other style.

Whereas the present invention has been described in particular relation to the drawings and photos attached hereto it should be understood that other and further modifications apart from those suggested herein may be made within the spirit and scope of the invention.

Thus, there has been described a new and unique bead assist device wheel for mounting oversized tires for use on street vehicles and for vehicles used in the off-road industry. This design will prevent tubeless tires from being separated from the wheel during sharp turns or in adverse conditions and will effectively prevent drivers from losing control and lessen the likelihood of overturned vehicle accidents.

### REFERENCE NUMBERS

10—Invention
20—Wheel
30—Inner locking ring set
40—Front outer wheel lip
50—Deep drop center
60—Hex nuts
70—Central circular opening
80—Stud opening
90—Vent holes
100—Spokes
110—Central wheel support
120—Button head hex screws
130—Outer edge of wheel
140—Hub width plane
150—Rear edge of wheel
160—Inner diameter of wheel
170—Central support surface
180—Locking pin
190—Locking ring mounting hole
200—Studs
210—Opening in stud
220—Rear of wheel
230—Rubber grommet
240—Stud head
270—Knurled surface of locking ring set
280—Rear side of locking ring set

What is claimed is:

1. A wheel designed to ensure a tire bead maintains direct and constant contact to the outer lip of wheel in adverse conditions by providing an inner locking ring secured by studs passed thru the wheel and fastened with hex nuts and locking pins.

2. The wheel according to claim 1 wherein the outer boss area is replaced by anchor points along the wheel hub within the deep drop center for securing fasteners.

3. The wheel according to claim 1 wherein bolts are inserted through the wheel perpendicular to prevent the tire bead from sliding off the outer lip of the wheel.

4. The wheel according to claim 1 wherein the locking ring set includes 4 segments creating a circular shape.

5. The wheel according to claim 1 wherein the locking ring set includes 5 segments creating a circular shape.

6. The wheel according to claim 1 wherein the wheel has spokes.

7. The wheel according to claim 1 wherein the wheel is solid.

8. The wheel according to claim 1 wherein inner locking rings have a knurled surface for means of engagement with the inner side of the tire bead.

9. The wheel according to claim 1 wherein inner locking rings have a saw tooth surface for means of engagement with the inner side of the tire bead.

10. The wheel according to claim 1 wherein rings are constructed of a hard plastic.

11. The wheel according to claim 1 wherein tire bead assist device is produced as a retro fit kit for existing standard wheels.

12. The wheel according to claim 1 wherein the studs originate from within the inside of the wheel

13. The stud according to claim 1 wherein the stud has an internally tapped or threaded head exposed to the outer side of wheel for attaching a button head screw for aesthetic look in addition to being an anchor point for a removable exterior protective ring.

14. The stud according to claim 1 wherein the stud has an internally tapped or threaded head exposed to the outer side of wheel for attaching a button head screw for an anchor point for a removable exterior protective ring.

15. A wheel according to claim 1 wherein the wheel is constructed of aluminum.

16. A wheel according to claim 1 wherein the wheel is constructed of steel.

17. A wheel according to claim 1 wherein the wheel is constructed whether in whole or in part using a welding process.

18. The wheel according to claim 1 wherein the inner locking ring sets are replaced by components designed to retain the tire bead.

19. The wheel according to claim 1 wherein the straight studs are replaced with pivotal studs shown in demonstration video for attachment of the inner locking ring set.

20. The wheel according to claim 1 wherein the studs and hex nuts are replaced with bolts as a clamping means.
